(19) United States
(12) Patent Application Publication
(10) Pub. No.: US 2026/0181588 A1
(43) Pub. Date: Jun. 25, 2026

(54) DETECTION OF SMARTPHONE USER'S INDOOR LOCATION

(71) Applicant: Samsung Electronics Co., Ltd., Suwon-si (KR)

(72) Inventors: Neha Dawar, McKinney, TX (US); Rebal Al Jurdi, Allen, TX (US); Abhishek Sehgal, Frisco, TX (US); Yuming Zhu, Plano, TX (US); Junsu Choi, Siheung-si (KR)

(21) Appl. No.: 19/420,708

(22) Filed: Dec. 15, 2025

Related U.S. Application Data
(60) Provisional application No. 63/738,424, filed on Dec. 23, 2024.

(51) Int. Cl. H04W 64/00; H04B 17/318

(52) U.S. Cl. CPC H04W 64/006; H04B 17/318

(57) ABSTRACT

Apparatuses and methods for an online detection of smartphone user's indoor location. A method of a network entity comprises: receiving, from a user equipment (UE), information including Wi-Fi scans; generating user location clusters based on the information; identifying a type of a motion state of a user based on inertial measurement unit (IMU) information; and updating the user location clusters based on the type of the motion state of the user.

### CROSS-REFERENCE TO RELATED APPLICATIONS AND CLAIM OF PRIORITY

The present application claims priority to U.S. Provisional Patent Application No. 63/738,424, filed on Dec. 23, 2024. The contents of the above-identified patent documents are incorporated herein by reference.

### TECHNICAL FIELD

The present disclosure relates generally to a location detection and, more specifically, the present disclosure relates to detection of smartphone user's indoor location.

### BACKGROUND

Due to the development of smart sensing technologies, sensor-based user spatial context detection has gained increasing popularity in human-computer interaction applications. Detecting the spatial context refers to identifying the geographical location of the user. A modern-day smartphone has access to a vast variety of sensors allowing on-the-go spatial or location context detection. Online location detection can be used to understand the user's behaviors and patterns, that is understanding if there is any specific application or action the user performs on the smartphone based on the location. For example, there could be a certain phone application that the user uses when they enter a specific geographical area (e.g., open a multimedia streaming app in the gym, or a particular shopping app when entering a particular store's building), or a certain setting or action that the user performs on the smartphone when they enter a specific geographical area (e.g., put the phone on silent when entering a conference room of the office). Understanding the user behaviors and patterns can be beneficial for a variety of applications and services, which includes recommending suitable applications or settings based on user's habits. In the present disclosure, a solution to perform online location clustering and detection using various sensors available in the smartphone is provided.

### SUMMARY

The present disclosure relates to detection of smartphone user's indoor location.

In one embodiment, a network entity in a wireless communication system is provided. The network entity comprises a transceiver configured to receive, from a user equipment (UE), information including Wi-Fi scans. The network entity further configured to: generate user location clusters based on the information, identify a type of a motion state of a user based on inertial measurement unit (IMU) information, and update the user location clusters based on the type of the motion state of the user.

In another embodiment, a method of a network entity in a wireless communication system is provided. The method comprises: receiving, from a UE, information including Wi-Fi scans; generating user location clusters based on the information; identifying a type of a motion state of a user based on IMU information; and updating the user location clusters based on the type of the motion state of the user.

In yet another embodiment, a UE in a wireless communication system is provided. The UE comprises a processor configured to generate information for user location clusters. The UE further comprises a transceiver configured to transmit, to a network entity, the information including Wi-Fi scans, wherein a type of a motion state of a user is identified based on IMU information and the user location clusters are updated based on the type of the motion state of the user.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a communication system according to various embodiments of the present disclosure;

FIG. 2 illustrates an example of an electronic device according to various embodiments of the present disclosure;

FIG. 3 illustrates an example of a network entity according to various embodiments of the present disclosure;

FIG. 4 illustrates a flowchart of a method for online clustering and inference for zone clustering according to various embodiments of the present disclosure;

FIG. 5 illustrates a flowchart of a method for bundle scans to form a super-scan according to various embodiments of the present disclosure;

FIG. 6 illustrates a flowchart of a method for online clustering and inference operation based on super scans according to various embodiments of the present disclosure;

FIG. 7 illustrates a flowchart of a method for identifying isolated outliers according to various embodiments of the present disclosure;

FIG. 8 illustrates a flowchart of a method for an updated stream clustering operation using super scans and updating the exemplars using isolated outliers according to various embodiments of the present disclosure;

FIG. 9 illustrates a flowchart of a method for a super clustering operation according to various embodiments of the present disclosure; and

FIG. 10 illustrates a flowchart of a method for an online detection of smartphone user's indoor location according to various embodiments of the present disclosure.

### DETAILED DESCRIPTION

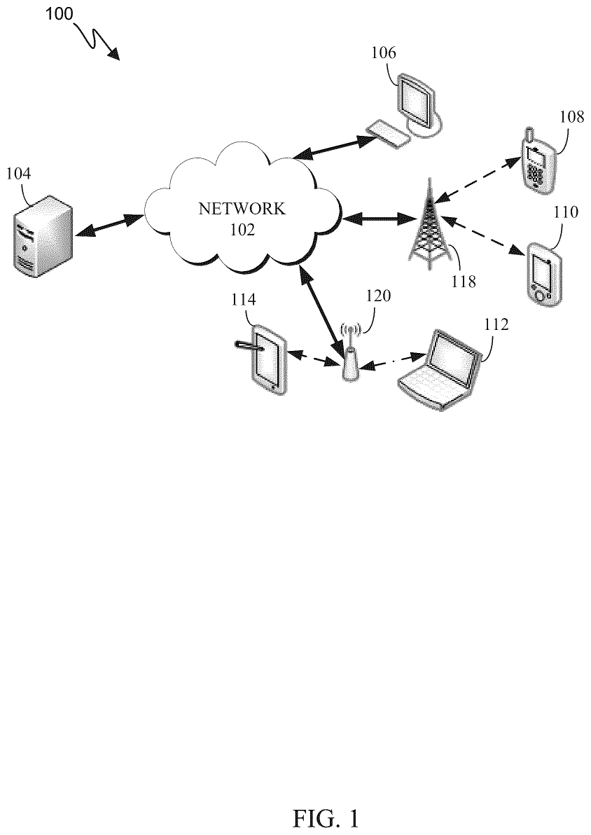

FIGS. 1-10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In many cases, solutions perform offline user's spatial context clustering and detection when all the data is available. There is a need for online spatial context detection on the smartphones to enable real-time personalized suggestions and recommendations based on the context.

FIG. 1 illustrates an example of a communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communications between various components in the communication system 100. For example, the network 102 can communicate internet protocol (IP) packets, frame relay frames, asynchronous transfer mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a TV, an interactive display, a wearable device, or an HMD. For certain embodiment, the client devices 106-114 may have various sensors allowing on-the-go spatial or location context detection. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-114.

Each client device 106-114 represents any suitable computing or processing device that interacts with at least one server (such as the server 104 as illustrated in FIG. 1) or other computing device(s) over the network 102. The client devices 106-114 include an electronic device performing a sensing operation, a desktop computer 106, a mobile telephone or mobile device 108 (such as a smartphone), a personal digital assistant (PDA) 110, a laptop computer 112, and a tablet computer 114. However, any other or additional client devices could be used in the communication system 100. The client devices 106-114 may include sensing system that may be independently and/or individually implemented, which may communicate with the network 102 and/or each of the client devices 106-114.

Specifically, the client device 106-114 including a sensing system can communicate with the network entity 102 and/or the client devices 106-114 and/or communicate with the server 104, one or more base stations 118 (e.g., cellular base stations or eNodeBs (eNBs)), or one or more wireless access points 120 as illustrated in FIG. 1.

In this example, some client devices 106-114 communicate indirectly with the network 102. For example, the mobile device 108 and PDA 110 communicate via one or more base stations 118, such as cellular base stations or eNodeBs (eNBs). Also, the laptop computer 112, and the tablet computer 114 communicate via one or more wireless access points 120, such as IEEE 802.11 wireless access points. Note that these are for illustration only and that each client device 106-114 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-114 can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

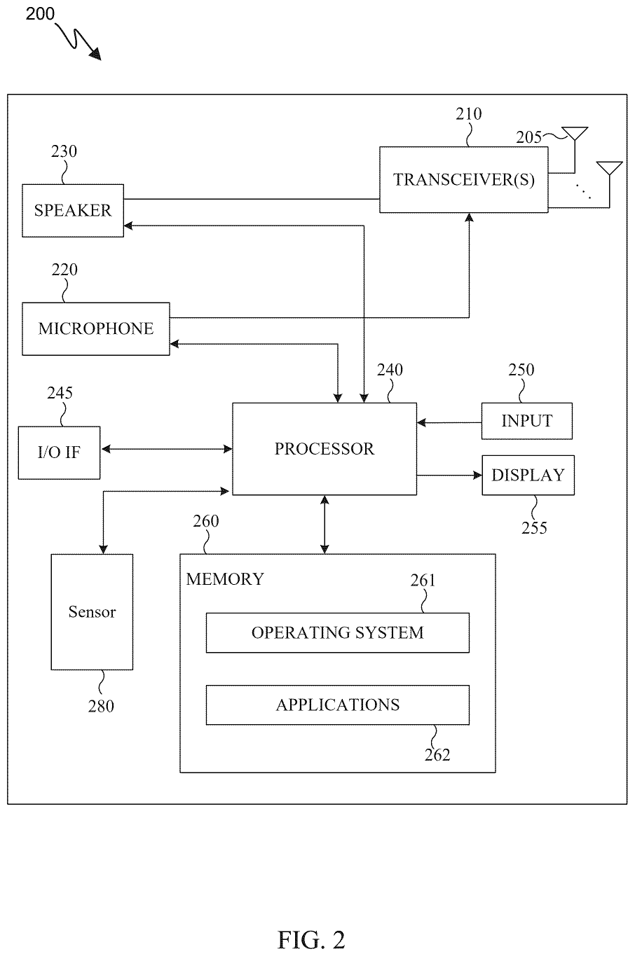

FIG. 2 illustrates an example of an electronic device 200 according to various embodiments of the present disclosure. The embodiment of the electronic device 200 (e.g., client device 106-114 as illustrated in FIG. 1) is for illustration only, and the electronic device 200 could have the same or similar configuration. However, the electronic devices come in a wide variety of configurations, and FIG. 2 does not limit the scope of this disclosure to any particular implementation of a UE.

As shown in FIG. 2, the electronic device 200 includes antenna(s) 205, a transceiver(s) 210, and a microphone 220. The electronic device 200 also includes a speaker 230, a processor 240, an input/output (I/O) interface (IF) 245, an input 250, a display 255, and a memory 260. The memory 260 includes an operating system (OS) 261 and one or more applications 262. The electronic device 200 further includes at least one sensor 280 to perform an online location clustering and detection using various sensors available in the electronic device (e.g., client device 106-114 as illustrated in FIG. 1).

The transceiver(s) 210 receives from the antenna 205, an incoming RF signal transmitted by a gNB of the network 100. The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 325 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors or other processing devices and execute the OS 261 stored in the memory 260 in order to control the overall operation of the electronic device 200. For example, the processor 240 could control the reception of DL channel signals and the transmission of UL channel signals by the transceiver(s) 210 in accordance with well-known principles. In some embodiments, the processor 240 includes at least one microprocessor or microcontroller.

The processor 240 is also capable of executing other processes and programs resident in the memory 260, such as processes to generate signals and/or information for supporting an online detection of smartphone user's indoor location in wireless communication systems.

The processor 240 can move data into or out of the memory 260 as required by an executing process. In some embodiments, the processor 240 is configured to execute the applications 262 based on the OS 261 or in response to signals received from gNBs or an operator. The processor 240 is also coupled to the I/O interface 245, which provides the electronic device 200 with the ability to connect to other devices, such as laptop computers and handheld computers. The I/O interface 245 is the communication path between these accessories and the processor 240.

The processor 240 is also coupled to the input 250 and the display 255m which includes for example, a touchscreen, keypad, etc., The operator of the electronic device 200 can use the input 250 to enter data into the electronic device 200. The display 255 may be a liquid crystal display, light emitting diode display, or other display capable of rendering text and/or at least limited graphics, such as from web sites.

In certain embodiment, the processor 240 is also capable of supporting an operation for an online detection of smartphone user's indoor location. In certain embodiment, the smartphone may be a client device (e.g., 106-114 as illustrated in FIG. 1).

The memory 260 is coupled to the processor 240. Part of the memory 260 could include a random-access memory (RAM), and another part of the memory 260 could include a Flash memory or other read-only memory (ROM).

Although FIG. 2 illustrates one example of electronic device 200, various changes may be made to FIG. 2. For example, various components in FIG. 2 could be combined, further subdivided, or omitted and additional components could be added according to particular needs. As a particular example, the processor 240 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 2 illustrates the electronic device 200 configured as a mobile telephone or smartphone, the electronic devices (e.g., client devices 106-114 as illustrated in FIG. 1) could be configured to operate as other types of mobile or stationary devices.

In certain embodiments, the electronic device 200 may perform, using at least one sensor 280, a sensor-based user spatial context detection that has gained increasing popularity in human-computer interaction applications. In certain embodiment, the electronic device 200 has access to a vast variety of sensors allowing on-the-go spatial or location context detection. In certain embodiment, the electronic device 200 performs online location clustering and detection using various sensors available in the smartphone.

In certain embodiments, the electronic device 200 may perform, using at least one sensor 280, a sensor-based user spatial context detection that has gained increasing popularity in human-computer interaction applications. In certain embodiment, the electronic device 200 has access to a vast variety of sensors allowing on-the-go spatial or location context detection. In certain embodiment, the electronic device 200 performs an operation for online location clustering and detection using various sensors available in the smartphone.

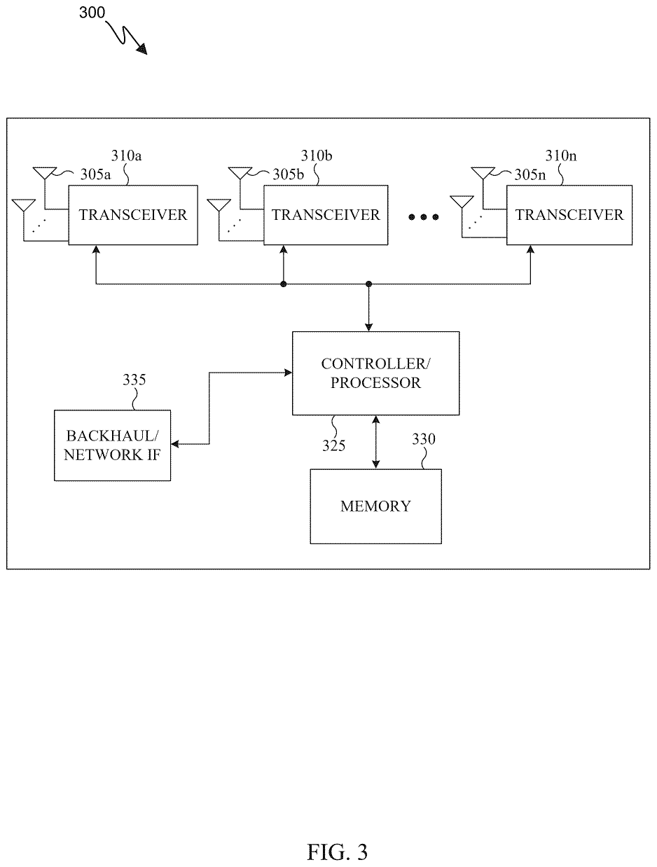

FIG. 3 illustrates an example of a network entity 300 according to various embodiments of the present disclosure. The embodiment of the network entity 300 illustrated in FIG. 3 is for illustration only, and the network entity 118 and 120 of FIG. 1 could have the same or similar configuration. However, the network entities come in a wide variety of configurations, and FIG. 3 does not limit the scope of this disclosure to any particular implementation of a network entity (e.g., base station (BS), gNB, NodeB).

As shown in FIG. 3, the network entity 300 (e.g., 118 and 120 as illustrated in FIG. 1) includes multiple antennas 305a-305n, multiple transceivers 310a-310n, a controller/processor 325, a memory 330, and a backhaul or network interface 335.

The transceivers 310a-310n receive, from the antennas 305a-305n, incoming RF signals, such as signals transmitted by a network entity (e.g., 118 and 120 as illustrated in FIG. 1, UEs) in the network 100. The transceivers 310a-310n down-convert the incoming RF signals to generate IF or baseband signals. The IF or baseband signals are processed by receive (RX) processing circuitry in the transceivers 310a-310n and/or controller/processor 325, which generates processed baseband signals by filtering, decoding, and/or digitizing the baseband or IF signals. The controller/processor 325 may further process the baseband signals.

Transmit (TX) processing circuitry in the transceivers 310a-310n and/or controller/processor 325 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 310a-310n up-converts the baseband or IF signals to RF signals that are transmitted via the antennas 305a-305n.

The controller/processor 325 can include one or more processors or other processing devices that control the overall operation of the network entity 300. For example, the controller/processor 325 could control the reception of UL channel signals and the transmission of DL channel signals by the transceivers 310a-310n in accordance with well-known principles. The controller/processor 325 could support additional functions as well, such as more advanced wireless communication functions. For instance, the controller/processor 325 could support beam forming or directional routing operations in which outgoing/incoming signals from/to multiple antennas 305a-305n are weighted differently to effectively steer the outgoing signals in a desired direction. Any of a wide variety of other functions could be supported in the network entity (e.g., 118 and 120 as illustrated in FIG. 1) by the controller/processor 325.

The controller/processor 325 is also capable of executing programs and other processes resident in the memory 330, such as processes to support an online detection of smartphone user's indoor location in a wireless communication network. The controller/processor 325 can move data into or out of the memory 230 as required by an executing process.

The controller/processor 325 is also coupled to the backhaul or network interface 335. The backhaul or network interface 335 allows the network entity 300 to communicate with other devices or systems over a backhaul connection or over a network. The interface 335 could support communications over any suitable wired or wireless connection(s). For example, when the network entity 302 is implemented as part of a wireless communication system (such as one supporting 5G/NR, LTE, or LTE-A), the interface 335 could allow the network entity 300 to communicate with other network entities over a wired or wireless backhaul connection. When the network entity 300 is implemented as an access point, the interface 335 could allow the network entity to communicate over a wired or wireless local area network or over a wired or wireless connection to a larger network (such as the Internet). The interface 335 includes any suitable structure supporting communications over a wired or wireless connection, such as an Ethernet or transceiver.

The memory 330 is coupled to the controller/processor 325. Part of the memory 330 could include a RAM, and another part of the memory 330 could include a Flash memory or other ROM. In certain embodiments, the controller/processor 325 supports an online detection of smartphone user's primary location.

Although FIG. 3 illustrates one example of network entity, various changes may be made to FIG. 3. For example, the network entity could include any number of each component shown in FIG. 3. Also, various components in FIG. 3 could be combined, further subdivided, or omitted and additional components could be added according to particular needs.

Location services play a key role in modern digital applications by enabling personalized and context-aware services. User's spatial context detection can be useful on a coarser level, for e.g., a home region, a work region, etc., or on a finer level, for e.g., zones within the home region (kitchen, living room, bedroom) or the work region (conference room, cafeteria) or a combination of the two. A smartphone is generally equipped with global positioning system (GPS), WiFi and inertial measurement unit (IMU) sensors and one or more of these components are used to detect the spatial context of the user.

A higher-level primary location detection can be performed using longer-range geolocation technologies, such as global navigation satellite system (GNSS) and cellular network, while a finer level indoor location detection can be performed using shorter-range wireless technologies such as Wi-Fi and Bluetooth.

In the present disclosure, a solution to cluster and detect the indoor location of the user using Wi-Fi scans and IMU measurements is provided. Clustering involves forming of indoor location or zone clusters, while detection performs inference of Wi-Fi scans to the formed zone clusters.

In the present disclosure following embodiments are provided.

In one embodiment, a generating operation of user location clusters is provided when a threshold amount of Wi-Fi scans is received, wherein a newly received Wi-Fi scan is utilized to infer with which user location cluster the newly received Wi-Fi scan is associated and wherein an outlier Wi-Fi scan is used to determine whether to perform user location re-clustering.

In one embodiment, a forming operation of super-scans is provided based on Wi-Fi scans and IMU to pre-process the Wi-Fi scans to generate the user location clusters, wherein the IMU information is used to determine a motion state of a user including whether the user is moving or stationary.

In one embodiment, an updating operation of representatives of the user location clusters is provided when inference fluctuates between valid clusters and outlier clusters when the user is determined as being stationary.

In one embodiment, a super clustering operation is provided to merge clusters that have high similarity.

In one embodiment, Wi-Fi scans are used to identify zones in indoor locations. Zones refer to the fine-grained locations where the user spends considerable amount of time. Some examples of zones are different rooms within a home, or conference room or cafeteria within an office environment. The Wi-Fi scans are represented as the set of scanned access points (APs) represented in terms of their BSSIDs along with their corresponding received signal strength indicators (RSSIs). Zone clustering can be performed using fingerprints of Wi-Fi scans. A similar metric is used to calculate the closeness between the scans. This similarity metric is then used to cluster the scans using a shallow clustering operation, for example DBScan, OPTICS, affinity propagation.

In one embodiment, cosine similarity using preprocessed RSSI values is used as the similarity metric. If xᵢ and xⱼ represent two scans as shown in equation (1):

$${x}_{i} = \{ {ap}_{1}^{i} , rss {i}_{1}^{i} \} , \{ {ap}_{2}^{i} , rss {i}_{2}^{i} \} , … , \{ {ap}_{u}^{i} , rss {i}_{u}^{i} \} \qquad ( 1 )$$

$${x}_{j} = \{ {ap}_{1}^{j} , rss {i}_{1}^{j} \} , \{ {ap}_{2}^{j} , rss {i}_{2}^{j} \} , … , \{ {ap}_{v}^{j} , {rssi}_{v}^{j} \}$$

In equation 1, ap represents the BSSIDs of the APs and rssi represent their corresponding RSSI values. In one embodiment, scans are pre-processed before calculating the cosine similarity. The minimum RSSI (rssiₘᵢₙ) across all scans is calculated. The RSSI values of the scans are replaced with a positive value as shown in equation (2):

$${rssi}_{jp}^{i} = {rssi}_{j}^{i} - ( {rssi}_{m i n}^{i} - 1 ) \qquad ( 2 )$$

The scans are normalized using their maximum value as shown in equation (3)

$${rssi}_{j , norm}^{i} = \frac{{rssi}_{j , p}^{i}}{{rssi}_{m ax , p}} , {rssi}_{j , norm}^{i} ∈ [ 0 , 1 ] , {rssi}_{m ax , p} = {max}_{j} {rssi}_{j , p}^{i} \qquad ( 3 )$$

Power transformation of normalized data is calculated as shown in equation (4).

$${rssi}_{j , pp}^{i} = {( {rssi}_{j , norm}^{i} )}^{a} \qquad ( 4 )$$

Let RSSI_{i,pp} and RSSI_{j,pp} represent the pre-processed RSSI sets of scans xᵢ and xⱼ respectively. As the scans may be mismatched due to absence of some APs in one of the two scans, to find the union of the two scans, the missing RSSI values are replaced with 0. The cosine similarity score is defined as shown in equation (5).

$${S}_{c os} ( {x}_{i} , {x}_{j} ) = \frac{{RSSI}_{i , pp} \cdot {RSSI}_{j , pp}}{‖ {RSSI}_{i , pp} ‖ ‖ {RSSI}_{j , pp} ‖} \qquad ( 5 )$$

Other similarity metrics that can be used include Shepard similarity, inverse Minkowski distance and Jaccard similarity.

To implement clustering and updating the zones as new scans are received, an on-the-fly clustering operation is performed. Because of its ability to handle streaming data and update zones based on unseen data, streaming affinity propagation to perform stream clustering is provided.

Affinity propagation is a partitioning based clustering operation that can automatically determine the number of clusters making it particularly useful for situations where the cluster numbers are unknown or difficult to determine. The operation identifies examples from the dataset. Exemplars are representative data points that best represent the cluster. The operation is based on the concept of message passing between the data points. Messages are iteratively exchanged between the data points to determine the most suitable exemplars for each data point. Both the similarity between the data points, and their suitability as exemplary are considered to provide robust and accurate clustering results.

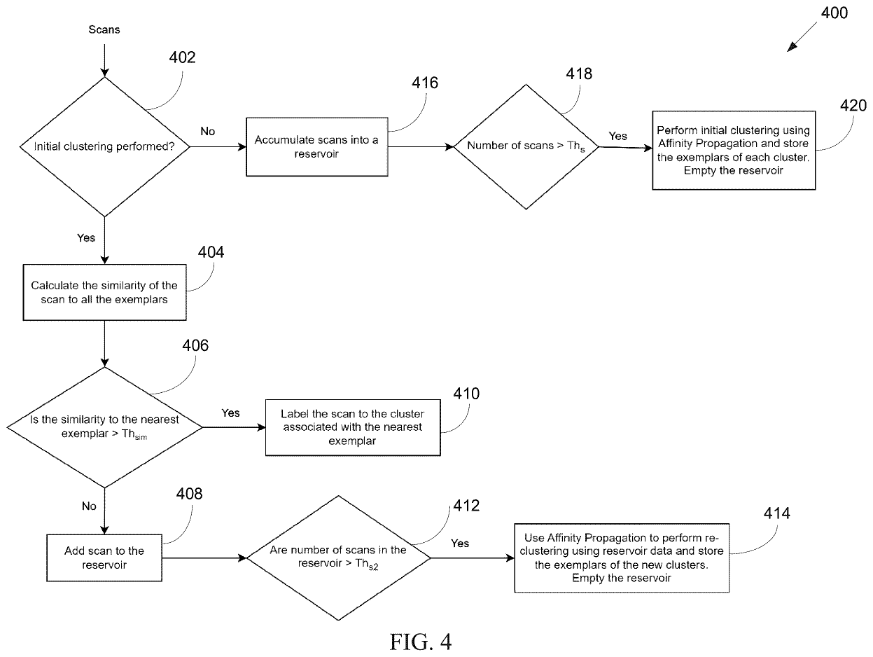

Cosine similarity is used as the similarity metric in affinity propagation clustering operation. To initially cluster zones from streaming scans and then to perform incremental clustering as new scans keep coming in, the online clustering and inference operation is used based on streaming affinity propagation shown in FIG. 4.

FIG. 4 illustrates a flowchart of a method 400 for online clustering and inference for zone clustering according to various embodiments of the present disclosure. The method 400 may be performed by a network entity (e.g., 118 and 120 as illustrated in FIGS. 1 and 3000 as illustrated in FIG. 3). An embodiment of the method 400 shown in FIG. 4 is for illustration only. One or more of the components illustrated in FIG. 4 can be implemented in a specialized circuitry configured to perform the noted functions or one or more of the components can be implemented by one or more processors executing instructions to perform the noted functions.

As illustrated in FIG. 4, the method 400 begins at step 402. In step 402, if initial clustering is not yet performed, scans are accumulated into a reservoir in step 416. When sufficient number of scans have been accumulated in step 418, initial clustering is performed using affinity propagation and the exemplars of the formed clusters are stored, and the reservoir is emptied in step 420. After initial clustering is performed, as a new scan is received, inference is performed by calculating its similarity to all the exemplars in step 404. If the similarity to the nearest exemplar (exemplar with the highest similarity) is above a threshold in step 406, the scan is labeled to the cluster associated with the nearest exemplar in step 410. If the similarity to the nearest exemplar is not above the threshold in step 406, this outlier scan is added to the reservoir in step 408. When sufficient outlier scans are accumulated in the reservoir in step 412, Affinity propagation is used again on the reservoir data to form new clusters in step 414.

Sometimes a change in the environment could lead to significantly different scan signatures at the same location. Hence, clustering operation results in the formation of multiple clusters for a single location. In one embodiment, a super-scan, which is a single scan representing multiple scans, is used to perform clustering. Super-scan is derived by averaging multiple scans at the same location. To ensure that the scans used to form a super-scan are from the same location, an IMU sensor of the device is used. A mobility information is obtained from the measurements of IMU sensor that suggests whether the user is walking or stationary. Scans are accumulated to form a super-scan only when the user is stationary. For the stationary scans, a super-scan is generated by taking an average over all RSSI values per AP.

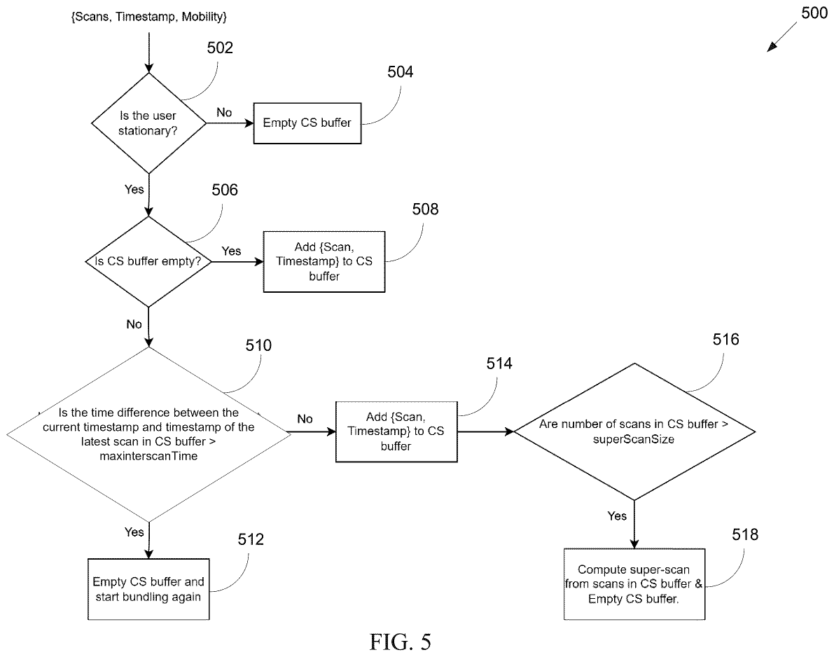

FIG. 5 illustrates a flowchart of a method 500 for bundle scans to form a super-scan according to various embodiments of the present disclosure. The method 500 may be performed by a network entity (e.g., 118 and 120 as illustrated in FIGS. 1 and 300 as illustrated in FIG. 3). An embodiment of the method 400 shown in FIG. 5 is for illustration only. One or more of the components illustrated in FIG. 5 can be implemented in a specialized circuitry configured to perform the noted functions or one or more of the components can be implemented by one or more processors executing instructions to perform the noted functions.

In one embodiment, the operation method described in FIG. 5 is used to accumulate scans to form a super-scan. Scans are accumulated in a buffer called continuous scans buffer, or CS buffer. While the user is stationary, the scans along with their timestamps are bundled into CS buffer as long as the timestamp difference between two consecutive scans is below a MaxInterscanTime threshold. If the number of scans in CS buffer exceed a value, superScanSize, the scans in the CS buffer are used to compute a super-scan and the CS buffer is emptied.

As illustrated in FIG. 5, the method 500 begins at step 502. In step 502, whether the user is stationary is determined. If the user is not stationary, CS buffer becomes empty in step 504. If the user is stationary, in step 506, whether the CS buffer is empty is determined. In step 506, the CS buffer is empty, in step 508, the timestamp is scanned and added to the CS buffer. In step 506, the CS buffer is not empty, in step 510, the time difference is measured between the current timestamp and the timestamp of the later scanned. In step 510, the difference exceeds the MaxInterscanTime, CS buffer becomes empty and the bundling starts again in step 512. In step 510, the difference does not exceed the MaxInterscanTime, in step 514, the time stamp is added to the CS buffer. In step 516, a number of scans is measured. In step 516, the measured number of scans exceed the superScanSize, in step 518, super-scan is computed from scans in CS buffer and the CS buffer becomes empty.

In one embodiment, the super-scan is generated by taking the average of RSSI values per AP for all the scans. The super scan is represented as a set of all the APs present in the scans over which the super scan is calculated, along with their average RSSI values across all the scans. In an alternate embodiment, the super scan is generated by taking the weighted average of the RSSI values over the scans in which the AP appeared.

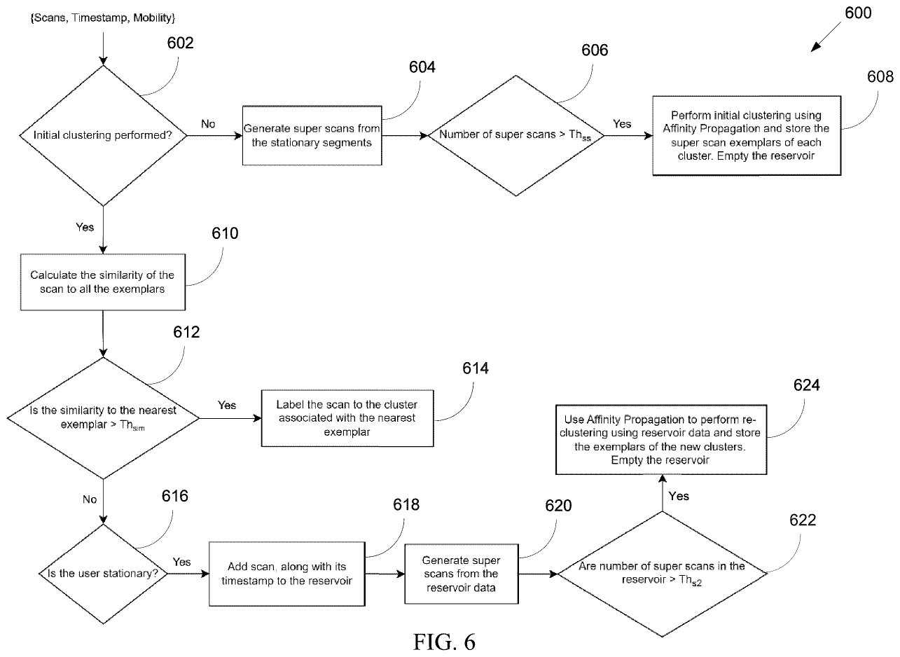

FIG. 6 illustrates a flowchart of a method 600 for online clustering and inference operation based on super scans according to various embodiments of the present disclosure. The method 600 may be performed by a network entity (e.g., 118 and 120 as illustrated in FIGS. 1 and 300 as illustrated in FIG. 3). An embodiment of the method 600 shown in FIG. 6 is for illustration only. One or more of the components illustrated in FIG. 6 can be implemented in a specialized circuitry configured to perform the noted functions or one or more of the components can be implemented by one or more processors executing instructions to perform the noted functions.

The block diagram of the online clustering and inference approach based on super scans is shown in FIG. 6. When initial clustering has not been performed, scans within the same time window are bundled to form a super scan when the user is stationary. When sufficient super scans have been generated, initial clustering is performed using affinity propagation and the exemplary of the clusters are stored. To perform inference, the similarity of the new cluster is calculated to all the super scan exemplars. If the similarity with the nearest exemplar is above a threshold, the scan is inferred to the cluster belonging to that exemplar, and if not, the scan is added to the reservoir only if the user is stationary. Super scans are continuously generated from the reservoir scans. When the number of super scans formed from the reservoir scans exceed a threshold, re-clustering is performed.

As illustrated in FIG. 6, the method 600 begins at step 602. In step 602, the method determines whether the initial clustering is performed. When the initial clustering is performed, in step 610, the similarity of the scan is calculated. In step 612, the similarity is compared with the threshold. In step 612, the similarity exceeds the threshold, in step 614, the scan is labelled to the cluster. In step 612, the similarity does not exceed the threshold, in step 616, whether the user is stationary is determined. In step 618, the scan of the user is added to the reservoir. In step 620, super scans are generated from the reservoir data. In step 622, a number of super scan is measured based on a threshold. In step 624, affinity propagation is used when the number of super scan exceeds the threshold. In step 602, if the initial clustering is not performed, in step 604, the super scans are generated from the stationary segments. In step 606, a number of super scans is measured based on a threshold. In step 608, the initial clustering is performed using affinity propagation when the number of super scans exceed the threshold.

When the user is stationary, the scans are expected to infer to the same cluster. However, it could sometimes happen that the inference fluctuates between multiple clusters. Or sometimes, the fluctuation can be between inferring a cluster and marking a scan as an outlier. In this case, since the user is stationary, the outlier scans may belong to the cluster of the inferred scans. Hence, in one embodiment, the exemplar of the inferred scan is updated so that it can also represent the isolated outliers and reduce the number of outliers in the future.

Isolated outliers refer to single outliers received in between inferred clusters. For example, if Cᵢ represents the inferred cluster and O represents an outlier, the sequence like {Cᵢ, Cᵢ, Cᵢ, O, Cᵢ} represents an isolated outlier. In this embodiment, only a single outlier in between multiple inferences is used to update the exemplar. In other words, consecutive outliers in between multiple inferences are not used to update the exemplar, for example {Cᵢ, Cᵢ, Cᵢ, O, O, Cᵢ}. Single isolated outliers provide more confidence on the scan being an outlier, hence in this embodiment, single isolated outliers are used to update exemplars.

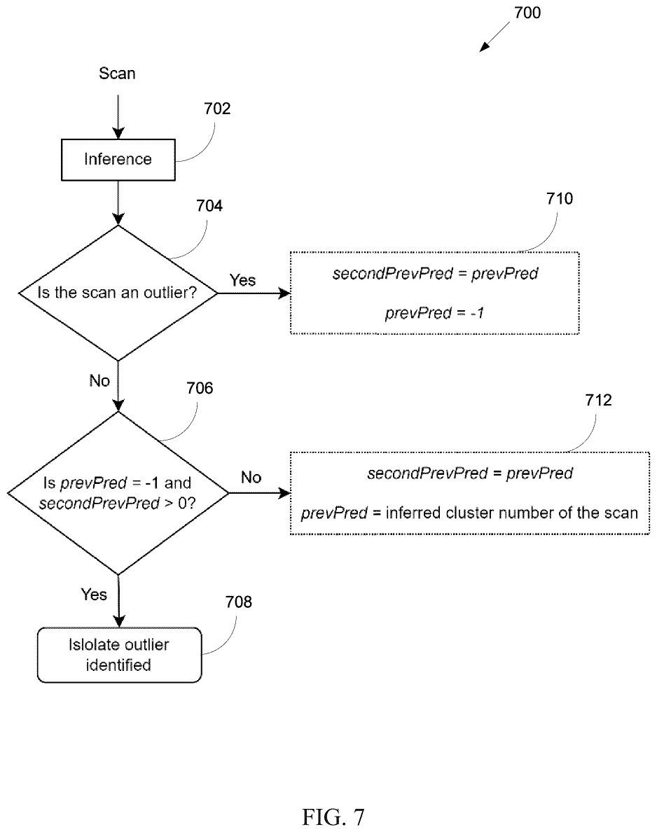

FIG. 7 illustrates a flowchart of a method 700 for identifying isolated outliers according to various embodiments of the present disclosure. The method 700 may be performed by a network entity (e.g., 118 and 120 as illustrated in FIGS. 1 and 300 as illustrated in FIG. 3). An embodiment of the method 700 shown in FIG. 7 is for illustration only. One or more of the components illustrated in FIG. 7 can be implemented in a specialized circuitry configured to perform the noted functions or one or more of the components can be implemented by one or more processors executing instructions to perform the noted functions.

In one embodiment, the operation to identify isolated outliers is shown in FIG. 7. As illustrated in FIG. 7, the method 700 begins at step 702. In step 702, inference is identified. In step 704, whether the scan is outlier is determined. In step 704, the scan is outlier, in step 710, two variables prevPred and secondPrevPred are used to store the predictions of the previous two scans. If the scans are an outlier, a value −1 is stored for the corresponding variable. If the current prediction is not an outlier in step 704, and prevPred=−1 and secondPrevPred>0 (indicating that the secondPrevPred was not an outlier in step 706), an isolated outlier is identified in step 708. In step 706, if no, prevPred is set to an inferred cluster number of the scan. Note that there is a delay of one scan interval to identify an isolated outlier.

In one embodiment, in order to update the exemplars, the count of scans used to generate the super-scans are stored and are used to update the super scan exemplar. If SSₑ represents the super scan exemplar, kₑ represents the number of scans that were used to form this super scan, and Sₒ represents the outlier scan, the updated super scan exemplar, SS_{e,updated}, is calculated as shown in equation (6).

$$S {S}_{e , updated} = \frac{S {S}_{e} \cdot {k}_{e} + {S}_{o}}{( {k}_{e} + 1 )} \qquad ( 6 )$$

The number of scans used to form the super scan is incremented as well, as shown in equation (7).

$${k}_{e , updated} = {k}_{e} + 1 \qquad ( 7 )$$

This can be done for every isolated outlier received in between inferred scans.

In one embodiment, multiple consecutive outliers can also be used in the same way to update the exemplars.

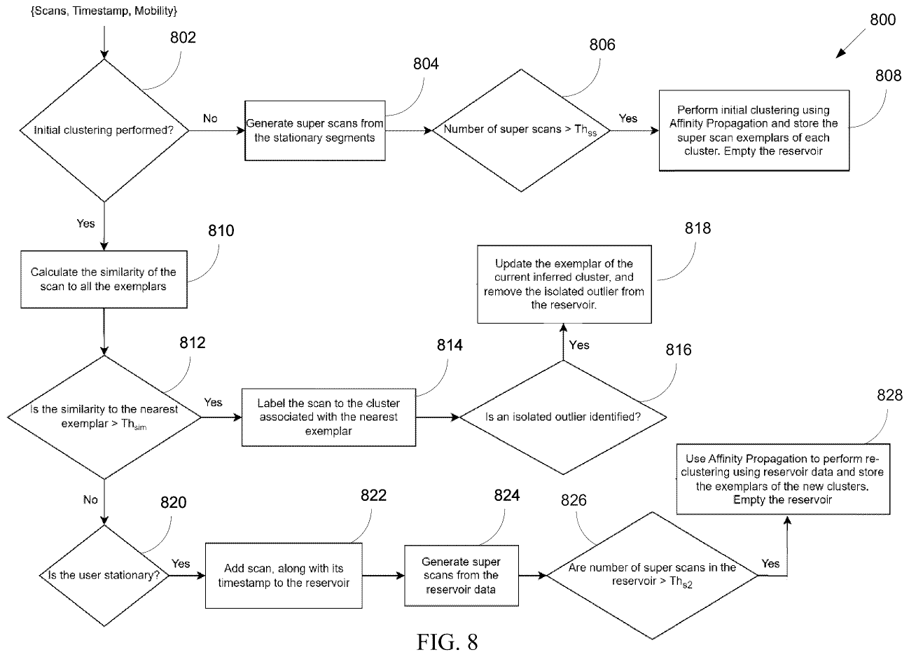

The updated online clustering and inference operation using super scans and updating the exemplary upon receiving isolated outliers is shown in FIG. 8.

FIG. 8 illustrates a flowchart of a method 800 for an updated stream clustering operation using super scans and updating the exemplars using isolated outliers according to various embodiments of the present disclosure. The method 800 may be performed by a network entity (e.g., 118 and 120 as illustrated in FIGS. 1 and 300 as illustrated in FIG. 3). An embodiment of the method 800 shown in FIG. 8 is for illustration only. One or more of the components illustrated in FIG. 8 can be implemented in a specialized circuitry configured to perform the noted functions or one or more of the components can be implemented by one or more processors executing instructions to perform the noted functions.

As illustrated in FIG. 8, the method 800 begins at step 802. In step 802, the method 800 determines whether the initial clustering is performed. In step 802, the clustering is not performed, in step 804, generate super scans. In step 806, the method 800 compares a number of super scans with a threshold. In step 808, if the number of super scans exceeds the threshold, the initial clustering is performed using affinity propagations. In step 810, the similarity of the scan to all the exemplars is calculated. In step 812, the method 800 determines whether the similarity exceeds a threshold. In step 812, if the similarity exceeds the threshold, in step 814, the scan is labelled to the cluster. In 816, the method 800 determines whether an isolated outlier is identified. In step 816, the outlier is identified, in step 818, the exemplars of the outlier is updated and the isolated outlier is removed. In step 812, if the similarity does not exceed the threshold, in step 820, the method 800 determines whether the user is stationary. In step 820, if the user is stationary, in step 822, the scan is added to the reservoir. In step 824, the super scans are generated from the reservoir data. In step 826, the method 800 determines whether a number of super scans exceeds a threshold. In step 826, if the number of super scans exceeds the threshold, in step 828, the affinity propagation is used to perform re-clustering using the reservoir data and store the exemplars of the new clusters, and the reservoir becomes empty.

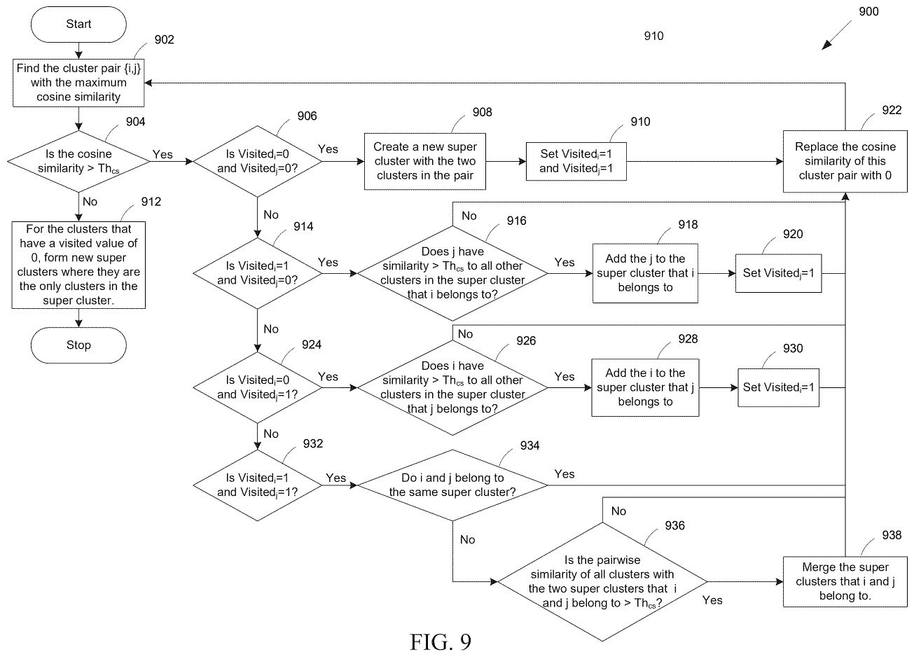

In one embodiment, super clustering is performed after each clustering to improve the clustering performance by merging multiple clusters formed for the same location. To perform super clustering, cosine distance between the exemplars of the formed clusters is used. The super clustering operation method is shown in FIG. 9.

FIG. 9 illustrates a flowchart of a method 900 for a super clustering operation according to various embodiments of the present disclosure. The method 900 may be performed by a network entity (e.g., 118 and 120 as illustrated in FIGS. 1 and 300 as illustrated in FIG. 3). An embodiment of the method 900 shown in FIG. 9 is for illustration only. One or more of the components illustrated in FIG. 9 can be implemented in a specialized circuitry configured to perform the noted functions or one or more of the components can be implemented by one or more processors executing instructions to perform the noted functions.

As illustrated in FIG. 9, the method 900 begins at step 902. In step 902, a network entity (e.g., 118 and 120 as illustrated in FIGS. 1 and 300 as illustrated in FIG. 3) fins the cluster pair with a maximum cosine similarity. In step 904, the network determines whether the cosine similarity is greater than Th_{CS}. In step 904, if the cosine similarity is greater than Th_{CS}, the network entity, in step 906, determines if Visitedᵢ and Visitedⱼ are set to zero. In step 904, if it is not greater than Th_{CS}, the method 900 performs step 912. In step 906, those are set to zero, the network entity in step 908 creates a new super cluster with the two clusters in the pair. In step 906, if it is not set to zero, the method 900 performs step 914. In step 910, the network entity sets Visitedᵢ and Visitedⱼ as one, and then the network entity performs step 922. In step 922, the network entity replaces the cosine similarity of this cluster pair with zero. In step 904, if not, the network entity, for the clusters that have a visited value of zero, forms new super clusters where they are the only clusters in the super cluster in step 912. In step 906, if not, the network entity determines in step 914 whether Visitedᵢ is set to one and Visitedⱼ is set to zero. In step 914, if Visitedᵢ is set to one and Visitedⱼ, the network entity determines in step 916 whether j has similarity greater than Th_{CS} to all other clusters in the super cluster that I belongs to. In step 914, if it does not meet the condition. The method 900 performs step 924. In step 916, if the condition meets, in step 918, the network entity adds the j to the super cluster that i belongs to. In step 920, the network entity sets Visited as one, and then the network entity in step 922 replaces the cosine similarity of this cluster pair with zero. In step 914, if not, the network entity determines in step 924 whether Visitedᵢ is set to 0 and Visitedⱼ is set to one. In step 924, if the condition meet, the network entity determines in step 926 whether i has similarity greater than Th_{CS} to all other clusters in the super cluster that j belongs to. In step 926, if the condition meets, the network entity in step 928 adds I to the super cluster that j belongs to, and then, in step 930 the network entity sets Visitedᵢ as one. In step 926, if the condition is not met, the method 900 performs step 922. In step 924, if the condition does not meet, the network entity in step 932 determines whether Visitedᵢ is set to one and Visitedⱼ is set to one. In step 932, if the condition meets, the network entity determines in step 934 whether i and j belong to the same super cluster, and then the network entity performs 922. In step 934, if the condition does not meet, the network entity determines in step 936 whether the pairwise similarity of all clusters within the two super clusters that i and j belongs to is greater than Th_{CS}. In step 936, if the condition meets, the network entity in step 938 merges with the super clusters that I and j belong to, and then the network entity performs step 922. In step 936, if the condition is not met, the method 900 performs step 922.

Firstly, the pairwise cosine similarity between all pairs of exemplars is calculated. A variable Visited; is maintained for each cluster i, which states whether that cluster has already been added to a super cluster or not. Vistiedᵢ=0 indicates that the exemplary of cluster i has not been added to a super cluster, and Visitedᵢ=1 indicates that the exemplary of cluster i has been added to a super cluster. To start the operation, the cluster pair {i, j} with the maximum cosine similarity is provided.

If the similarity is above a threshold, following operation is performed.

In one example, if Visited value for both i and j is 0, a new super cluster is created with these two clusters in the pair, and Visited value for these clusters is set to 1.

In one example, if one of i and j have a Visited value of 1, the other one is checked with all other clusters in the super cluster that the cluster with the Visited value of 1 belongs to. Let us say that i has Visited value of 1, while j has a value 0. Only if j has a cosine similarity greater than the threshold to all other clusters in the super cluster that i belongs to, it is added to that super cluster and its Visited value is set to 1.

In one example, when both i and j have a Visited value of 1, if both of the clusters belong to the same super cluster, nothing is done. Else, if they belong to different super clusters, pairwise cosine similarity of all the clusters between these two super clusters is checked. If all the cosine similarities between every pair of the super clusters is above the threshold, the two super clusters are merged.

In all cases, the Visited value of both i and j is set to 1 if it is not already 1. The cosine similarity of pair {i, j} is set to 0 so that the pair with the next highest cosine similarity can be obtained. These steps are repeated until all the clusters have a Visited value of 1. This super clustering is performed right after performing clustering or re-clustering of the super-scans.

In one embodiment, super clustering can be performed at the inference level. If the user is identified as stationary, and the inference of the Wi-Fi scans is switching between two or more clusters, the pair-wise cosine similarity can be calculated between the two or more clusters. If the cosine similarity exceeds a threshold, the clusters are merged.

In another embodiment, a two-layer super clustering is performed, where the first super clustering is performed after performing clustering or re-clustering of super scans as illustrated in FIG. 8. The second super clustering is performed at inference level when the user is stationary and the inference is fluctuation between multiple clusters.

In one embodiment, clusters are periodically checked to remove any stale or unused clusters. A timestamp, representing the last time the cluster was visited, is associated with each cluster. If the time when the cluster was last visited exceeds a certain time threshold, which could be a few months or years, the cluster is removed and its exemplar is deleted. This step prevents unnecessary memory blow up by ensuring that the clusters which were wrongly formed (for example, multiple clusters formed at a location which are not merged by the super-clustering operation) are constantly monitored and eventually removed if not visited sufficiently.

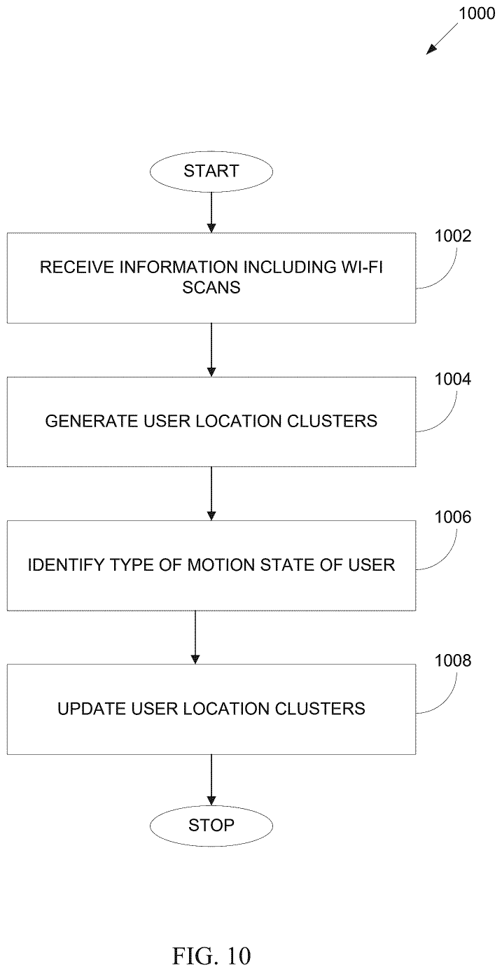

FIG. 10 illustrates a flowchart of a method 1000 for an online detection of smartphone user's indoor location according to various embodiments of the present disclosure. The method 1000 may be performed by a network entity (e.g., 118 and 120 as illustrated in FIGS. 1 and 300 as illustrated in FIG. 3). An embodiment of the method 1000 shown in FIG. 10 is for illustration only. One or more of the components illustrated in FIG. 10 can be implemented in a specialized circuitry configured to perform the noted functions or one or more of the components can be implemented by one or more processors executing instructions to perform the noted functions.

As illustrated in FIG. 10, the method 1000 beings at step 1002, in step 1002, a network entity receives, from a UE, information including Wi-Fi scans.

Subsequently, the network entity in step 1004 generates user location clusters based on the information.

Next, the network entity in step 1006 identifies a type of a motion state of a user based on IMU information.

Finally, the network entity in step 1008 updates the user location clusters based on the type of the motion state of the user.

In one embodiment, the network entity performs a pre-processing operation on the Wi-Fi scans to generate a scan and identifies, based on the scan, at least one zone in an indoor environment. In such embodiment, the at least one zone is associated with the user location clusters.

In one embodiment, a super scan is identified when the type of the motion state of the user indicates a stationary state of the user, the super scan is identified based on multiple pre-processed scans at a same location in an indoor environment, and the super scan is used for an initial clustering operation.

In one embodiment, the network entity identifies similarity between the Wi-Fi scans based on preprocessed RSSI values and the user location clusters.

In one embodiment, the network entity receives a new Wi-Fi scan that is a latest scan; determines whether the new Wi-Fi scan belongs to the user location clusters that is a valid user location cluster or is an outlier; and identifies a user location cluster among the user location clusters based on a determination that the new Wi-Fi scan is a valid scan.

In one embodiment, the network entity determines whether inferences fluctuate between clusters included in the generated user location clusters and outliers and updates the user location clusters based on a determination that the inferences fluctuate, the type of the motion state of the user indicating a stationary state of the user.

In one embodiment, the network entity counts a number of outlier Wi-Fi scans and store the number of the outlier Wi-Fi scans for generating a super scan and determines, based on the number of outlier Wi-Fi scans, whether to perform an operation for re-clustering the user location clusters. In such embodiment, the super scan is identified based on multiple scans at a same location in an indoor environment when the type of the motion state of the user indicated stationary state of the user.

In one embodiment, the network entity forms, based on a level of similarity among the user location clusters, a super cluster for merging the user location clusters with other user location clusters.

In one embodiment, an operation for forming the super cluster is performed after forming the user location clusters.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A network entity in a wireless communication system, the network entity comprising:
a transceiver configured to receive, from a user equipment (UE), information including Wi-Fi scans; and
a processor operably coupled to the transceiver, the processor configured to:
generate user location clusters based on the information,
identify a type of a motion state of a user based on inertial measurement unit (IMU) information, and
update the user location clusters based on the type of the motion state of the user.

2. The network entity of claim 1, wherein the processor is further configured to:
perform a pre-processing operation on the Wi-Fi scans to generate a scan; and
identify, based on the scan, at least one zone in an indoor environment, and
wherein the at least one zone is associated with the user location clusters.

3. The network entity of claim 1, wherein:
a super scan is identified when the type of the motion state of the user indicates a stationary state of the user;
the super scan is identified based on multiple pre-processed scans at a same location in an indoor environment; and
the super scan is used for an initial clustering operation.

4. The network entity of claim 1, wherein the processor is further configured to identify similarity between the Wi-Fi scans based on preprocessed received signal strength indicator (RSSI) values and the user location clusters.

5. The network entity of claim 1, wherein:
the transceiver is further configured to receive a new Wi-Fi scan that is a latest scan; and
the processor is further configured to:
determine whether the new Wi-Fi scan belongs to the user location clusters that is a valid user location cluster or is an outlier, and
identify a user location cluster among the user location clusters based on a determination that the new Wi-Fi scan is a valid scan.

6. The network entity of claim 1, wherein the processor is further configured to:
determine whether inferences fluctuate between clusters included in the generated user location clusters and outliers; and
update the user location clusters based on a determination that the inferences fluctuate, the type of the motion state of the user indicating a stationary state of the user.

7. The network entity of claim 1, wherein the processor is further configured to:
count a number of outlier Wi-Fi scans and store the number of the outlier Wi-Fi scans for generating a super scan; and
determine, based on the number of outlier Wi-Fi scans, whether to perform an operation for re-clustering the user location clusters, and
wherein the super scan is identified based on multiple scans at a same location in an indoor environment when the type of the motion state of the user indicated stationary state of the user.

8. The network entity of claim 1, wherein the processor is further configured to form, based on a level of similarity among the user location clusters, a super cluster for merging the user location clusters with other user location clusters.

9. The network entity of claim 8, wherein an operation for forming the super cluster is performed after forming the user location clusters.

10. A method of a network entity in a wireless communication system, the method comprising:
receiving, from a user equipment (UE), information including Wi-Fi scans;
generating user location clusters based on the information;
identifying a type of a motion state of a user based on inertial measurement unit (IMU) information; and
updating the user location clusters based on the type of the motion state of the user.

11. The method of claim 10, further comprising:
performing a pre-processing operation on the Wi-Fi scans to generate a scan; and
identifying, based on the scan, at least one zone in an indoor environment,
wherein the at least one zone is associated with the user location clusters.

12. The method of claim 10, wherein:
a super scan is identified when the type of the motion state of the user indicates a stationary state of the user;
the super scan is identified based on multiple pre-processed scans at a same location in an indoor environment; and
the super scan is used for an initial clustering operation.

13. The method of claim 10, further comprising identifying similarity between the Wi-Fi scans based on preprocessed received signal strength indicator (RSSI) values and the user location clusters.

14. The method of claim 10, further comprising:
receiving a new Wi-Fi scan that is a latest scan;
determining whether the new Wi-Fi scan belongs to the user location clusters that is a valid user location cluster or is an outlier; and
identifying a user location cluster among the user location clusters based on a determination that the new Wi-Fi scan is a valid scan.

15. The method of claim 10, further comprising:
determining whether inferences fluctuate between clusters included in the generated user location clusters and outliers; and
updating the user location clusters based on a determination that the inferences fluctuate, the type of the motion state of the user indicating a stationary state of the user.

16. The method of claim 10, further comprising:
counting a number of outlier Wi-Fi scans and storing the number of the outlier Wi-Fi scans for generating a super scan; and
determining, based on the number of outlier Wi-Fi scans, whether to perform an operation for re-clustering the user location clusters,
wherein the super scan is identified based on multiple scans at a same location in an indoor environment when the type of the motion state of the user indicated stationary state of the user.

17. The method of claim 10, further comprising forming, based on a level of similarity among the user location clusters, a super cluster for merging the user location clusters with other user location clusters.

18. The method of claim 17, wherein an operation for forming the super cluster is performed after forming the user location clusters.

19. A user equipment (UE) in a wireless communication system, the UE comprising:
a processor configured to generate information for user location clusters; and
a transceiver operably coupled to the processor, the transceiver configured to transmit, to a network entity, the information including Wi-Fi scans,
wherein a type of a motion state of a user is identified based on inertial measurement unit (IMU) information and the user location clusters are updated based on the type of the motion state of the user.

20. The UE of claim 19, wherein:
the transceiver is further configured to transmit, to the network entity, a new Wi-Fi scan that is a latest scan;
whether the new Wi-Fi scan belongs to the user location clusters that is a valid user location cluster or is an outlier is determined; and
a user location cluster among the user location clusters is identified based on a determination that the new Wi-Fi scan is a valid scan.
